(19) United States
(12) Patent Application Publication
(10) Pub. No.: US 2017/0277372 A1
(43) Pub. Date: Sep. 28, 2017

(54) DISPLAY APPARATUS FOR CONTROLLING HUB, METHOD OF CONTROLLING THE SAME AND SYSTEM THEREOF

(71) Applicant: SAMSUNG ELECTRONICS CO., LTD., Suwon-si (KR)

(72) Inventor: Jun-sik CHOI, Seoul (KR)

(73) Assignee: SAMSUNG ELECTRONICS CO., LTD., Suwon-si (KR)

(21) Appl. No.: 15/455,298

(22) Filed: Mar. 10, 2017

(30) Foreign Application Priority Data
Mar. 22, 2016 (KR) 10-2016-0033819

(51) Int. Cl. G06F 3/0482; G06F 3/0484

(52) U.S. Cl. CPC G06F 3/0482; G06F 3/04847; G08C 2200/00

(57) ABSTRACT

A display apparatus including: a display; a communicator configured to communicate with a third hub; a user input configured to receive a user's input; and a processor configured: to receive information about a list of apparatuses, which are connected to a first hub and a second hub using a different protocol from the first hub, through the third hub, to control the display to display a list of first electronic apparatuses connected to the first hub and second electronic apparatuses connected to the second hub based on the received information about the list of apparatuses, and to control an operation of an electronic apparatus selected by a user's input to the user input among the first electronic apparatuses and the second electronic apparatuses.

### CROSS-REFERENCE TO RELATED the APPLICATION

This application claims priority from Korean Patent Application No. 10-2016-0033819 filed on Mar. 22, 2016 in the Korean Intellectual Property Office, the disclosure of which is incorporated herein by reference.

### BACKGROUND

Field

Apparatuses and methods consistent with the exemplary embodiments relate to a display apparatus for controlling a hub, a method of controlling the same and a system thereof, in which many electronic apparatuses are connected for communication in accordance with preset protocols to thereby control a hub of establishing a unit network, and more particularly to a display apparatus for controlling a hub, a method of controlling the same and a system thereof, in which the hub has a structure for more conveniently and easily performing connection between unit networks based on different protocols.

Description of the Related Art

To compute and process predetermined information in accordance with certain processes, an electronic apparatus basically includes a central processing unit (CPU), a chipset, a memory, and the like electronic components for computation. Such an electronic apparatus may be classified variously in accordance with what information will be processed therein. For example, the electronic apparatus is classified into an information processing apparatus such as a personal computer, a server or the like for processing general information, and an image processing apparatus for processing image information. The image processing apparatus, a display apparatus, an information processing apparatus or the like electronic apparatus is a single entity that performs a previously given function by itself.

A plurality of electronic apparatuses may connect with each other for communication and thus constitute a system of a unit network. Under this system, the electronic apparatuses may work together to perform various extended functions that cannot be performed in the single entity. As a general and simple example of such a system, there is a home network established within a home. Here, the system may be involved in not only a typical electronic apparatus but also a unit network established by mounting a sensor and a communication module to an electric lamp or the like entity having a simple function. For instance, this concept includes the Internet of Things (IoT).

The Internet of Things refers to technology of utilizing various things, each of which has a sensing function and a communicating function, are connected by a network, e.g. Internet. Here, the things refer to various unit devices connected to the network and communicating with one another, and may for example include a refrigerator, a washing machine, a boiler and the like home appliances; an electric lamp, an electric heater and the like light and heat devices; a television (TV), a set-top box and the like image processing apparatuses; a computer, a mobile phone, a tablet computer and the like information processing apparatuses; etc. To connect the things, i.e. to connect the respective devices to one unit network, a certain thing has to make the other things connect and communicate with one another in accordance with preset protocols. As an example of the certain thing, there is a hub.

If two unit networks support different protocols, it may be difficult to connect a thing of one unit network and a thing of the other unit network or to connect a thing not affiliated with these two unit networks and the thing of each unit network. Therefore, it will be preferable if there is a method of making a predetermined thing connect and communicate with the things of the unit networks supporting different protocols.

### SUMMARY

A display apparatus including: a display; a communicator configured to communicate with a third hub; a user input configured to receive a user's input; and a processor configured: to receive information about a list of apparatuses, which are connected to a first hub and a second hub using a different protocol from the first hub, through the third hub, to control the display to display a list of first electronic apparatuses connected to the first hub and second electronic apparatuses connected to the second hub based on the received information about the list of apparatuses, and to control an operation of an electronic apparatus selected by a user's input to the user input among the first electronic apparatuses and the second electronic apparatuses. Thus, the display apparatus can use the third hub to easily control the electronic apparatuses not directly connected to the third hub. Further, the first hub and the second hub provide the third hub with the list of electronic apparatuses connected to the first hub and the second hub, and therefore the third hub does not have to register the electronic apparatuses individually.

The processor may control the display to display a user interface (UI) for changing a setting value of a current environmental setting state of the electronic apparatus selected in the list, and may transmit information about the setting value changed through the UI to the electronic apparatus selected in the list. Thus, the display apparatus can easily control various states of the electronic apparatus through the UI.

The processor may acquire setting information about the first electronic apparatuses and the second electronic apparatuses from the first hub and the second hub, may store the acquired setting information in the third hub, and may determine a current environmental setting state of the electronic apparatus selected in the list based on the stored setting information. Thus, the display apparatus can easily acquire setting information about the electronic apparatus.

The user input may be configured to receive a user's input from a remote controller.

The display apparatus may include the third hub.

A method of controlling a display apparatus, the method including: communicating with a third hub; receiving information about a list of apparatuses, which are connected to a first hub and a second hub using a different protocol from the first hub, through the third hub; displaying a list of first electronic apparatuses connected to the first hub and second electronic apparatuses connected to the second hub based on the received information about the list of apparatuses; and controlling an operation of an electronic apparatus selected by a user's input among the first electronic apparatuses and the second electronic apparatuses. Thus, the display apparatus can use the third hub to easily control the electronic apparatuses not directly connected to the third hub. Further, the first hub and the second hub provide the third hub with the list of electronic apparatuses connected to the first hub and the second hub, and therefore the third hub does not have to register the electronic apparatuses individually.

The controlling an operation of an electronic apparatus selected by a user's input may include: displaying a user interface (UI) for changing a setting value of a current environmental setting state of the electronic apparatus selected in the list; and transmitting information about the setting value changed through the UI to the electronic apparatus selected in the list. Thus, the display apparatus can easily control various states of the electronic apparatus through the UI.

The method may further including: acquiring setting information about the first electronic apparatuses and the second electronic apparatuses from the first hub and the second hub, and storing the acquired setting information in the third hub; and determining a current environmental setting state of the electronic apparatus selected in the list based on the stored setting information. Thus, the display apparatus can easily acquire setting information about the electronic apparatus.

The user input may be configured to receive a user's input from a remote controller.

The display apparatus may include the third hub.

A system including: a first hub; a second hub using a different protocol from the first hub; a third hub connected to each of the first hub and the second hub, the third hub including: a communicator configured to communicate with each of the first hub and the second hub; a user input configured to receive a user's input; and a processor configured to receive information about a list of apparatuses connected to the first hub, control a display to display a list of first electronic apparatuses connected to the first hub and second electronic apparatuses connected to the second hub based on the received information about the list of apparatuses, and control an operation of an electronic apparatus selected by a user's input to the user input among the first electronic apparatuses and the second electronic apparatuses. Thus, the display apparatus can use the third hub to easily control the electronic apparatuses not directly connected to the third hub. Further, the first hub and the second hub provide the third hub with the list of electronic apparatuses connected to the first hub and the second hub, and therefore the third hub does not have to register the electronic apparatuses individually.

The first hub may be configured to use a first protocol and the second hub may be configured to use the second protocol, and the third hub may be configured to convert a command based on one of the first protocol and the second protocol, received from the first electronic apparatus or the second electronic apparatus, into a command based on the other one of the first protocol and the second protocol.

The third hub may include the display.

The processor may control the display to display a user interface (UI) for changing a setting value of a current environmental setting state of the electronic apparatus selected in the list, and may transmit information about the setting value changed through the UI to the electronic apparatus selected in the list. Thus, the display apparatus can easily control various states of the electronic apparatus through the UI.

The processor may acquire setting information about the first electronic apparatuses and the second electronic apparatuses from the first hub and the second hub, may store the acquired setting information in the third hub, and may determine a current environmental setting state of the electronic apparatus selected in the list based on the stored setting information. Thus, the display apparatus can easily acquire setting information about the electronic apparatus.

The communicator may communicate with an external apparatus including the display.

The user input may receive a user's input from the remote controller.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a system according to a first exemplary embodiment system;

FIG. 2 is a block diagram of illustrating a unit network established by a hub and an electronic apparatus in the system according to the first exemplary embodiment;

FIG. 3 is a block diagram of illustrating a method of integrating two unit networks in a system according to the second exemplary embodiment system;

FIG. 4 is a flowchart of controlling a master hub according to the second exemplary embodiment;

FIG. 5 is a flowchart of controlling a display apparatus according to a third exemplary embodiment;

FIG. 6 illustrates an example of a user interface (UI) showing connection states of electronic apparatuses, displayed on the display apparatus according to the third exemplary embodiment;

FIG. 7 illustrates an example of a UI showing setting items of a second electronic apparatus, displayed on the display apparatus according to the third exemplary embodiment; and

FIG. 8 is a block diagram of communication protocols between apparatuses in a system according to the third exemplary embodiment.

### DETAILED DESCRIPTION OF EXEMPLARY EMBODIMENTS

Below, exemplary embodiments will be described in detail with reference to accompanying drawings. The following descriptions of the exemplary embodiments are made by referring to elements shown in the accompanying drawings, in which like numerals refer to like elements having substantively the same functions.

In the description of the exemplary embodiments, an ordinal number used in terms such as a first element, a second element, etc. is employed for describing variety of elements, and the terms are used for distinguishing between one element and another element. Therefore, the meanings of the elements are not limited by the terms, and the terms are also used just for explaining the corresponding embodiment without limiting the idea of the invention.

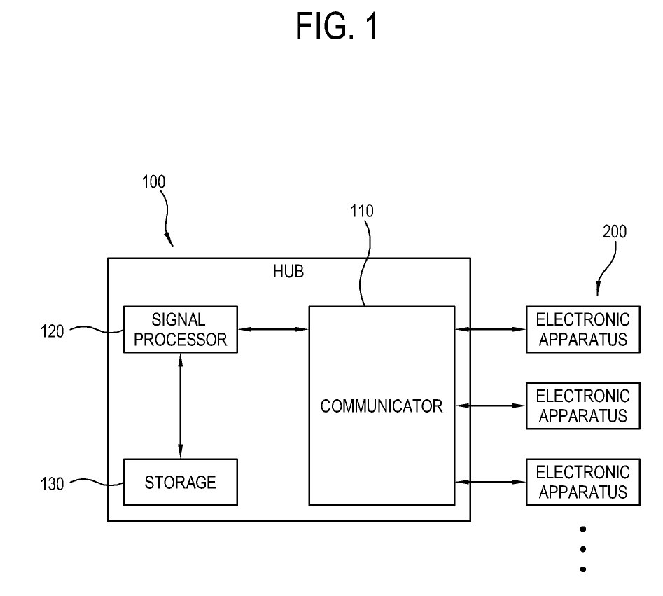

FIG. 1 is a block diagram of a system according to a first exemplary embodiment system.

As shown in FIG. 1, the system according to the first exemplary embodiment includes a plurality of electronic apparatuses 200. The plurality of electronic apparatuses 200 include unit entities or things having various kinds, shapes and functions without being limited to one kind. For example, the electronic apparatuses 200 may be achieved by a TV, an electronic picture frame and the like display apparatus for displaying an image; a set-top box and like image processing apparatus for processing an image signal without directly displaying an image; a washing machine, a refrigerator, an air conditioner and the like home appliances; a printer, a copy machine, a scanner and the like office machine; an electric lamp, an electric heater and the like devices; etc. Further, the electronic apparatuses 200 may be achieved by various wearable devices or mobile devices mounted with a sensor.

Like this, the electronic apparatuses 200 may be achieved differently, but all support a function of communication with the other electronic apparatuses 200.

Two electronic apparatuses 200 may communicate with each other by peer-to-peer connection, i.e. one-to-one connection. However, if the number of electronic apparatuses 200 increases, there are many limits to the one-to-one connection. In this regard, a communication relay device, i.e. a hub 100 is provided to connect and communicate with the plurality of electronic apparatuses 200. Among the electronic apparatuses 200 connected by one hub 100, a certain electronic apparatus 200 can communicate with another electronic apparatus 200 through the hub 100. For convenience, such a group including one hub 100 and the plurality of electronic apparatuses 200 connected to the hub 100 will be called one unit network.

The hub 100 refers to a device for connecting the electronic apparatuses 200 in star topology within the unit network to which the hub 100 belongs. The hub 100 may be connected to a router (not shown), and thus connected to a wide area network (WAN) or the like parent network of the unit network.

The hub 100 may be achieved by any kind of device as long as if it serves as a communication relay within the unit network. As described above, all the electronic apparatuses supporting the communication may serve as the hub 100. For example, a TV may play a role of the hub 100.

The hub 100 includes a communicator 110 for communicating with each of the electronic apparatuses 200, a signal processor 120 for processing a signal received from a certain electronic apparatus 200 or transmitted to another electronic apparatus 200 through the communicator 110, and a storage 130 for storing data.

The communicator 110 individually connects with the plurality of electronic apparatuses 200 and exchanges a signal with each of the electronic apparatuses 200. The communicator 110 communicates with the electronic apparatus 200 based on preset communication standards, and includes one or more wired ports or wireless communication modules for respectively connecting with the electronic apparatuses 200. The communicator 110 supports one or more wired/wireless communication standards such as Ethernet, ZigBee, Wi-Fi, etc., and thus performs communication with the electronic apparatus 200 based on corresponding communication protocols.

The signal processor 120 analyzes a signal if the signal from a certain electronic apparatus 200 is received in the communicator 110, determines which electronic apparatus 200 will receive the signal, and transfers the signal to the communicator 110 so that the signal can be transmitted to the determined electronic apparatus 200. In these operations, if the protocol of the signal received in the communicator 110 is different from the protocol for transmitting the signal, the signal processor 120 may convert the received signal to be adapted to the transmission protocol. The signal processor 120 may be achieved by a chipset group including a central processing unit (CPU), or a system-on-chip (SoC).

The storage 130 stores data processed by the signal processor 120. The storage 130 may include a flash memory, a hard disk drive, a solid state drive or the like nonvolatile memory.

Like this, the hub 100 supports one or more protocols according to the plurality of electronic apparatuses 200 within one unit network, and thus makes the electronic apparatuses 200 communicate with one another within one unit network.

In brief, the meaning of the protocol is as follows. In order to make the plurality of electronic apparatuses 200 work together and establish a unit network, they have to not only communicate with each other but also recognize and process a command exchanged between them. To this end, the plurality of electronic apparatuses 200 within one unit network operates based on common or compatible application or platform. For example, the electronic apparatus 200 at a transmitting side operates to process a signal based on a specific application or platform, and transmits the processed signal to the electronic apparatus 200 at a receiving side via the hub 100. The electronic apparatus 200 at the receiving side has the application or platform in common with the electronic apparatus 200 at the transmitting side, and therefore recognizes and processes the received signal. Like this, when the plurality of electronic apparatuses 200 operate based on the common or compatible application or platform, it will be also said that each of the electronic apparatuses 200 operates based on the common protocol.

Two or more unit networks may be provided in one system in accordance with types of the system. If two unit networks respectively support different protocols, i.e. if two unit networks are based on different applications or platforms, it is difficult to recognize and process a signal between the two unit networks. Therefore, there is a need of making these two unit networks connect and communicate with each other.

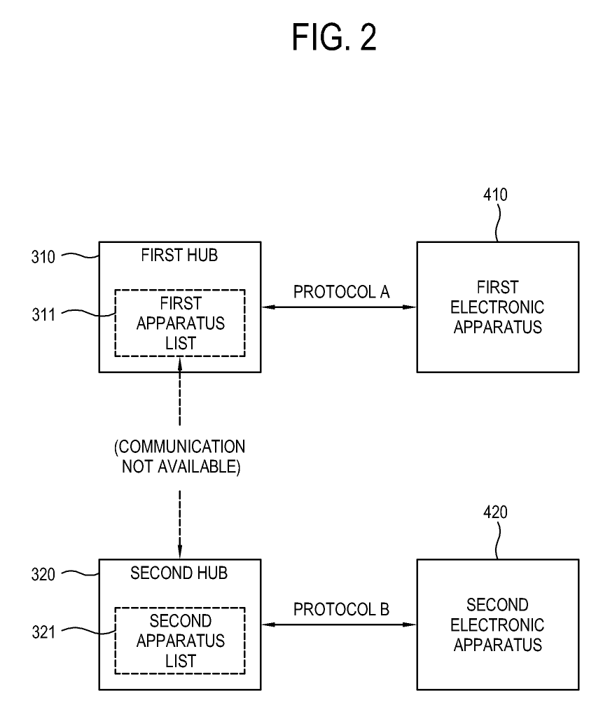

FIG. 2 is a block diagram of illustrating unit networks respectively established by hubs 310 and 320 and electronic apparatuses 410 and 420 in the system according to the first exemplary embodiment;

As shown in FIG. 2, the system includes a first hub 310 for establishing a first unit network, and a second hub 320 for establishing a second unit network. In this exemplary embodiment, each unit network includes one electronic apparatus 410 or 420, but this is to schematically explain the exemplary embodiment. In practice, each unit network may include a plurality of electronic apparatuses. However, this exemplary embodiment is applicable if one unit network includes the plurality of electronic apparatuses, but detailed descriptions thereof will be omitted.

To involve the first electronic apparatus 410 in the first unit network, the first electronic apparatus 410 has to connect and communicate with the first hub 310. To this end, the first hub 310 searches for the first electronic apparatus 410 in a communication network supported by the first hub 310, and registers the searched first electronic apparatus 410. Here, the registration of the first electronic apparatus 410 refers to an operation of the first hub 310 that connects and communicates with the first electronic apparatus 410 based on a specific protocol and records an item about the first electronic apparatus 410 in a first apparatus list 311.

The first apparatus list 311 refers to a list of electronic apparatuses connected to the first hub 310 and involved in the first unit network. In the first apparatus list 311, the electronic apparatuses connected to the first hub 310 like the first electronic apparatus 410, and protocols supported by the electronic apparatus are recorded. For example, if the first electronic apparatus 410 operates based on a protocol A, the first hub 310 records information about this in the first apparatus list 311.

Thus, the first hub 310 together with the first electronic apparatus 410 establishes the first unit network.

Likewise, the second hub 320 together with the second electronic apparatus 420 establishes the second unit network. The second hub 320 records an item about the second electronic apparatus 420 in the second apparatus list 321. For example, the second electronic apparatus 420 operates based on a protocol B, the second hub 320 records information about this in the second apparatus list 321.

With this structure, assume that the first electronic apparatus 410 or a separate electronic apparatus (not shown) connected to the first hub 310 tries communicating with the second electronic apparatus 420 in order to control the second electronic apparatus 420. If the protocol supported by the first hub 310 is the protocol A and the protocol supported by the second hub 320 is the protocol B, and the first hub 310 and the second hub 320 do not support a common or compatible protocol, the first electronic apparatus 410 cannot communicate with the second electronic apparatus 420.

For example, a command issued by the first electronic apparatus 410 is transmitted to the second electronic apparatus 420 via the first hub 310 and the second hub 320. This command is transmitted from the first electronic apparatus 410 as a command based on the protocol A, and therefore the command may be not transmitted to the second electronic apparatus 420 in accordance with apparatus characteristics or may be not normally recognized and processed by the second electronic apparatus 420 even though it is transmitted to the second electronic apparatus 420.

Accordingly, an exemplary embodiment of making communication possible between two unit networks based on different protocols will be described below.

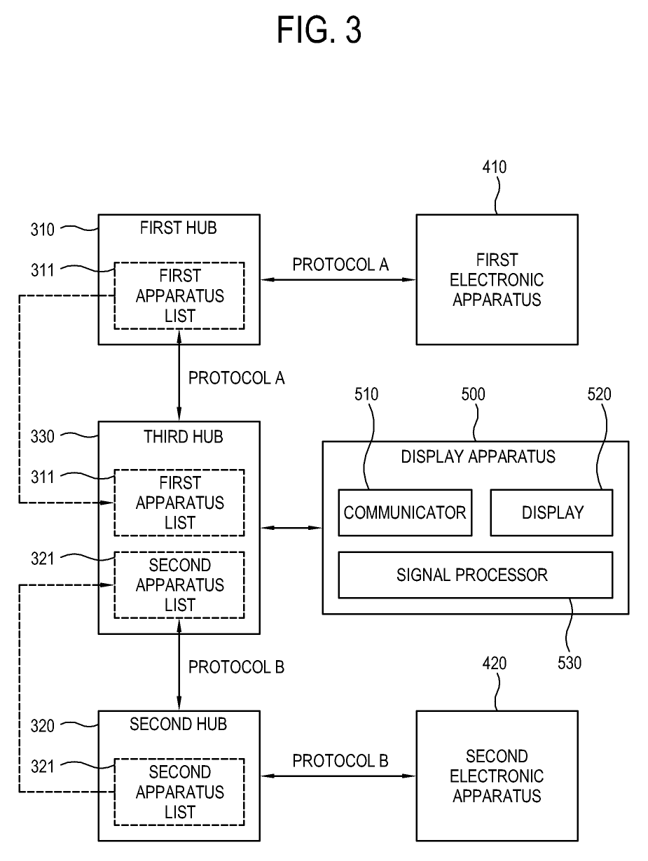

FIG. 3 is a block diagram of illustrating a method of integrating two unit networks in a system according to the second exemplary embodiment system.

As shown in FIG. 3, the system according to the second exemplary embodiment system includes the first unit network of the first hub 310 and the second unit network of the second hub 320. The first unit network includes the first hub 310, and the first electronic apparatus 410 connected to the first hub 310 and operating based on the protocol A. The second unit network includes the second hub 320, and the second electronic apparatus 420 connected to the second hub 320 and operating based on the protocol B.

Further, the first hub 310 stores the first apparatus list 311, and the second hub 320 stores the second apparatus list 321. The unit networks and the apparatus lists are equivalent to those of the foregoing descriptions, and thus repetitive descriptions will be avoided.

The connection between the first hub 310 and the first electronic apparatus 410 is based on the protocol A, and the connection between the second hub 320 and the second electronic apparatus 420 is based on the protocol B. Here, the first electronic apparatus 410 and the second electronic apparatus 420 are not directly connected to each other, and therefore the first electronic apparatus 410 and the second electronic apparatus 420 have to be connected to each other via the first hub 310 and the second hub 320 in the state that the first hub 310 and the second hub 320 are connected.

The first hub 310 and the second hub 320 do not support the common or compatible protocol. For example, if the protocol A supported by the first hub 310 supports and the protocol B supported by the second hub 320 are not compatible with each other, the first hub 310 and the second hub 320 cannot connect with each other.

According to an exemplary embodiment, a third hub 330 is provided for communication between the first hub 310 and the second hub 320. The details of the first hub 310, the second hub 320 and the third hub 330 are the same as those of the first exemplary embodiment. In addition, the third hub 330 supports the protocols for respectively communicating with the first hub 310 and the second hub 320.

For example, if the first hub 310 supports the protocol A and the second hub 320 supports the protocol B, it is difficult to connect the first hub 310 and the second hub 320 since there are no common protocols between them. However, if the third hub 330 supports both the protocol A and the protocol B, the third hub 330 can connect with the first hub 310 based on the protocol A and the second hub 320 based on the protocol B. That is, the third hub 330 serves as a master hub, i.e. a parent hub with regard to child hubs of the first hub 310 and the second hub 320.

Here, the third hub 330 may convert a command based on the protocol A into a command based on the protocol B, or convert a command based on the protocol B into a command based on the protocol A. To this end, the third hub 330 may have an application or platform for converting the commands.

Below, a method of establishing an integrated network, in which the first unit network and the second unit network are connected through the third hub 330, will be described.

The third hub 330 accesses the first hub 310 that belongs to the communication network of the third hub 330. The third hub 330 acquires and stores the first apparatus list 311 stored in the first hub 310. Further, the third hub 330 accesses the second hub 320 that belongs to the communication network of the third hub 330. The third hub 330 acquires and stores the second apparatus list 321 stored in the second hub 320.

The third hub 330 stores the acquired first and second apparatus lists 311 and 321, thereby acquiring information about the first electronic apparatus 410 recorded in the first apparatus list 311 and information about the second electronic apparatus 420 stored in the second apparatus list 321. Thus, the third hub 330 can access each of the electronic apparatuses 410 and 420 by just respectively acquiring the first apparatus list 311 and the second apparatus list 321 from the first hub 310 and the second hub 320 without performing the registration processes to the individual electronic apparatuses 410 and 420.

If the third hub 330 has no user control interface such as a display or the like, the third hub 330 may connect with a separate display apparatus 500 so that a user can control the third hub 330 through the display apparatus 500. The display apparatus 500 includes a communicator 510 for connecting and communicating with the third hub 330, a display 520 for displaying an image, and a signal processor 530 for processing a signal and computing an operation.

The display apparatus 500 accesses the first hub 310 that belongs to the communication network of the third hub 330 through the third hub 330. The display apparatus 500 acquires the first apparatus list 311 stored in the first hub 310 and stores the acquired first apparatus list 311 in the third hub 330. Further, the display apparatus 500 accesses the second hub 320 that belongs to the communication network of the third hub 330 through the third hub 330. The display apparatus 500 acquires the second apparatus list 321 stored in the second hub 320 and stores the acquired second apparatus list 321 in the third hub 330.

Thus, the third hub 330 integrates the first unit network of the first hub 310 and the second unit network of the second hub 320. The display apparatus 500 can communicate with each of the first electronic apparatus 410 and the second electronic apparatus 420 through the third hub 330, and control each of the first electronic apparatus 410 and the second electronic apparatus 420. In addition, the first electronic apparatus 410 may control the second electronic apparatus 420.

In the foregoing exemplary embodiment, the third hub 330 and the display apparatus 500 are provided as separate apparatuses. However, the third hub 330 and the display apparatus 500 may be integrated as a single apparatus. In this case, the third hub 330 includes general elements of the display apparatus 500 such as the display 520.

Below, a method of controlling the third hub 330, i.e. the master hub will be described according to this exemplary embodiment.

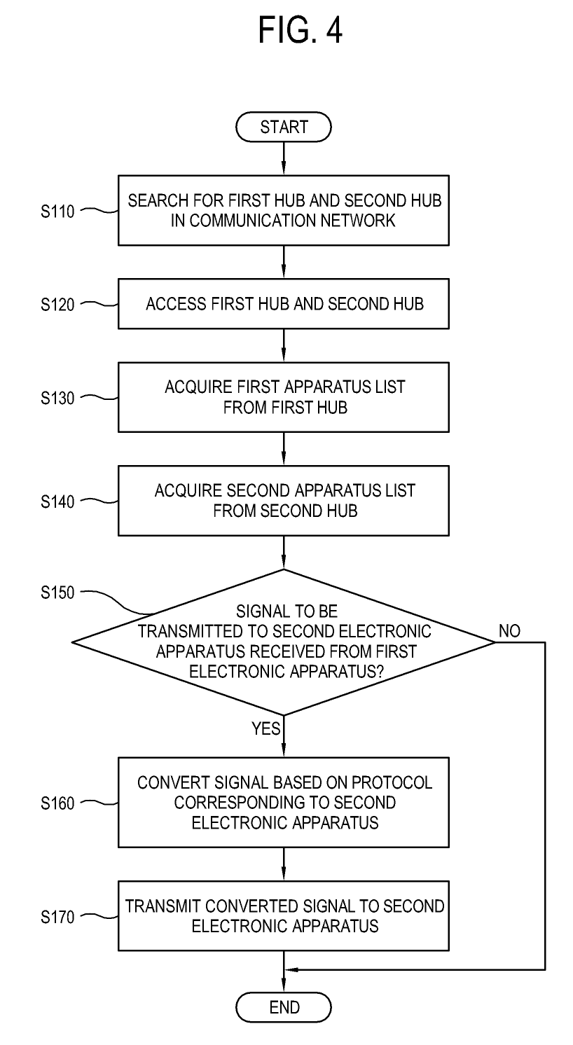

FIG. 4 is a flowchart of controlling the master hub according to the second exemplary embodiment.

As shown in FIG. 4, at operation S110, the master hub searches for the first hub and the second hub in the communication network.

At operation S120, the master hub accesses the first hub and the second hub.

At operation S130, the master hub acquires the first apparatus list from the first hub.

At operation S140, the master hub acquires the second apparatus list from the second hub. Thus, the master hub registers the first electronic apparatus and the second electronic apparatus based on the first apparatus list and the second apparatus list.

At operation S150, the master hub determines whether a signal to be transmitted to the second electronic apparatus is received from the first electronic apparatus.

If this signal is received, at operation S160 the master hub converts the signal based on the protocol corresponding to the second electronic apparatus.

At operation S170, the master hub transmits the converted signal to the second electronic apparatus.

Thus, the master hub connects the two unit networks based on different protocols.

Below, it will be described that the display apparatus connected to the master hub controls the master hub to register the first electronic apparatus and the second electronic apparatus to the master hub.

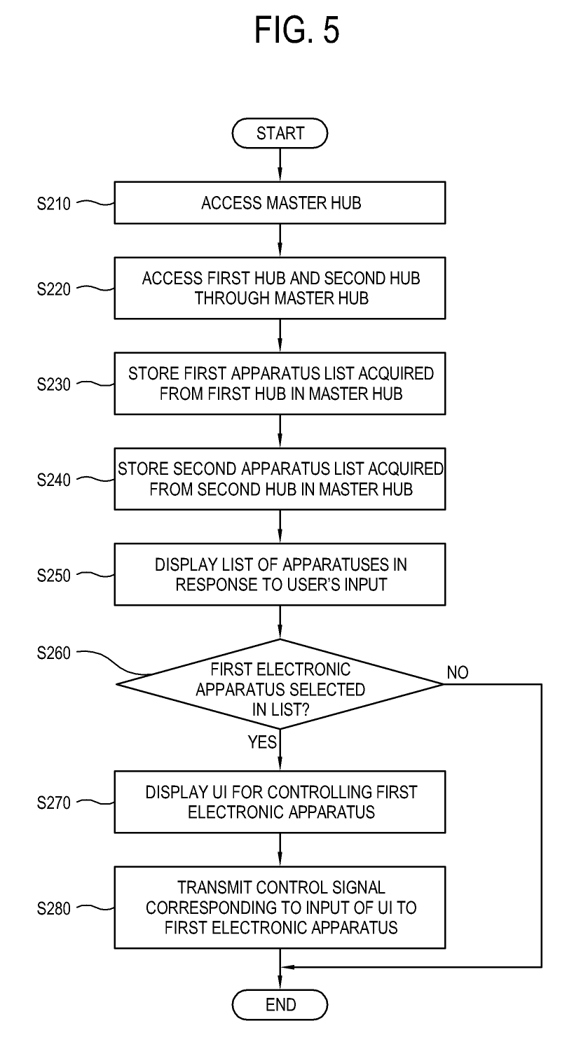

FIG. 5 is a flowchart of controlling the display apparatus according to a third exemplary embodiment.

As shown in FIG. 5, at operation S210 the display apparatus accesses the master hub.

At operation S220, the display apparatus accesses the first hub and the second hub via the master hub.

At operation S230, the display apparatus acquires the first apparatus list from the first hub and stores the acquired first apparatus list in the master hub.

At operation S240, the display apparatus acquires the second apparatus list from the second hub and stores the acquired second apparatus list in the master hub. Thus, the display apparatus accesses the first electronic apparatus or the second electronic apparatus through the master hub.

At operation S250, the display apparatus displays a list of electronic apparatuses registered in the master hub in response to a user's preset input.

At operation S260, the display apparatus determines whether an input for selecting the first electronic apparatus in the displayed list is received.

If this input is received, at operation S270 the display apparatus displays a UI for controlling operations of the first electronic apparatus.

At operation S280, the display apparatus sends the first electronic apparatus a control signal corresponding to the input using the UI. Thus, the first electronic apparatus performs an operation in response to the received control signal.

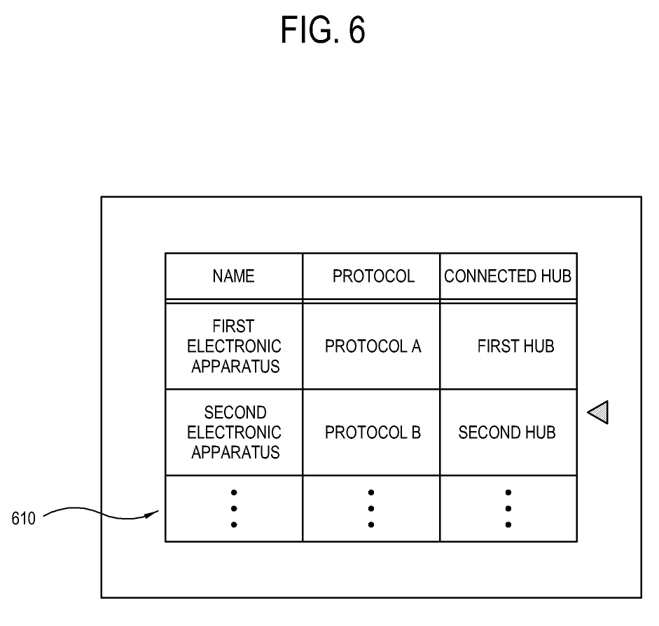

FIG. 6 illustrates an example of a UI 610 showing connection states of electronic apparatuses, displayed on the display apparatus according to the third exemplary embodiment;

As shown in FIG. 6, the display apparatus can display the UI 610 showing a list of electronic apparatuses connectable with the display apparatus. The UI 610 basically shows the name or identification (ID) of each electronic apparatus, and additionally shows the communication protocol of the electronic apparatus, the hub name of the unit network to which the electronic apparatus belongs, and the like information related to the electronic apparatus.

A user selects a desired electronic apparatus, for example, an item of the second electronic apparatus through the UI 610, thereby accessing the second electronic apparatus. If a user selects the item of the second electronic apparatus through the UI 610, the display apparatus may display setting items related to the second electronic apparatus in addition to the UI 610 or instead of the UI 610.

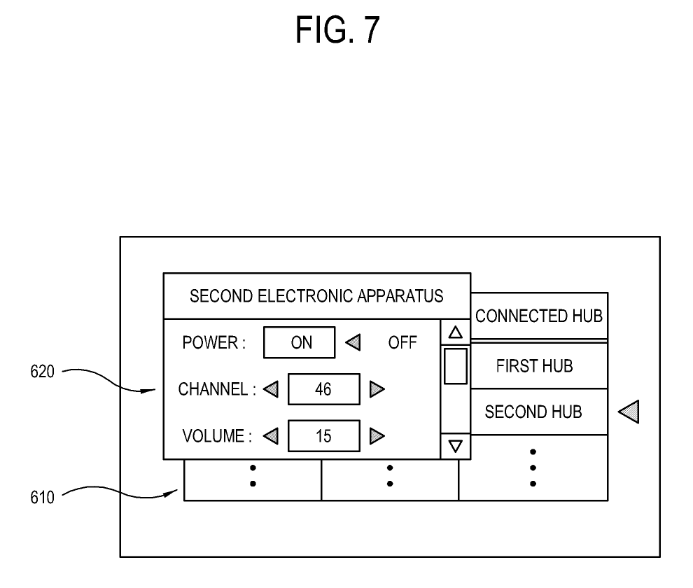

FIG. 7 illustrates an example of a UI 620 showing the setting items of the second electronic apparatus, displayed on the display apparatus according to the third exemplary embodiment

As shown in FIG. 7, the display apparatus displays the UI 620 showing environmental setting related to the second electronic apparatus if a user selects an access to the second electronic apparatus on the UI 610. The UI 620 includes items allowed to be changed by a user in the current settings of the second electronic apparatus.

Such items may be acquired from setting information about the second electronic apparatus stored together with the second apparatus list in the second hub in the foregoing exemplary embodiment. The display apparatus acquires the second apparatus list and the setting information from the second hub and stores them in the master hub. Details of the setting information will be described later.

When the UI 620 is displayed, the display apparatus acquires the setting information of the second electronic apparatus from the master hub, and displays the UI 620 by regarding the current setting values about the items of the second electronic apparatus as the initial values of the respective items. The UI 620 allows a user to adjust and change these initial values as desired.

The display apparatus transmits the values changed through the UI 620 to the second electronic apparatus via the master hub and the second hub, so that the second electronic apparatus can change the current state by the received setting values. Further, the setting information of the second electronic apparatus stored in the first hub and the second hub is updated with such changed item values.

Here, the setting information of the electronic apparatus may be information previously stored in the electronic apparatus, or information generated when the communication access is performed in between the hub and the electronic apparatus. The setting information includes network information needed for the electronic apparatus to access the hub, apparatus information about the structure of the electronic apparatus, state information about the current environmental setting states of the electronic apparatus, etc.

The network information refers to communication identification information by which the hub identifies a specific electronic apparatus among many apparatuses within the communication network in order to access the electronic apparatus.

The apparatus information refers to information showing a hardware or software structure of an electronic apparatus. For example, if the electronic apparatus includes a TV, the apparatus information includes hardware specifications such as the standards of the display and the processor; information of firmware; information about a driver, an operating system, an application and the like software.

The state information refers to information about the current setting states in the changeable setting environment of hardware or software of the electronic apparatus. For example, the state information shows whether the system is powered on or off, a brightness of a display, and a volume level of a loudspeaker, etc. in the electronic apparatus.

The hub stores such setting information in itself. When the master hub accesses the hub, the master hub can acquire and store the setting information and the apparatus list from the hub.

As the master hub accesses each of the first hub and the second hub, it is thus possible to communicate with and control the electronic apparatuses through the master hub and diversify the communication channels.

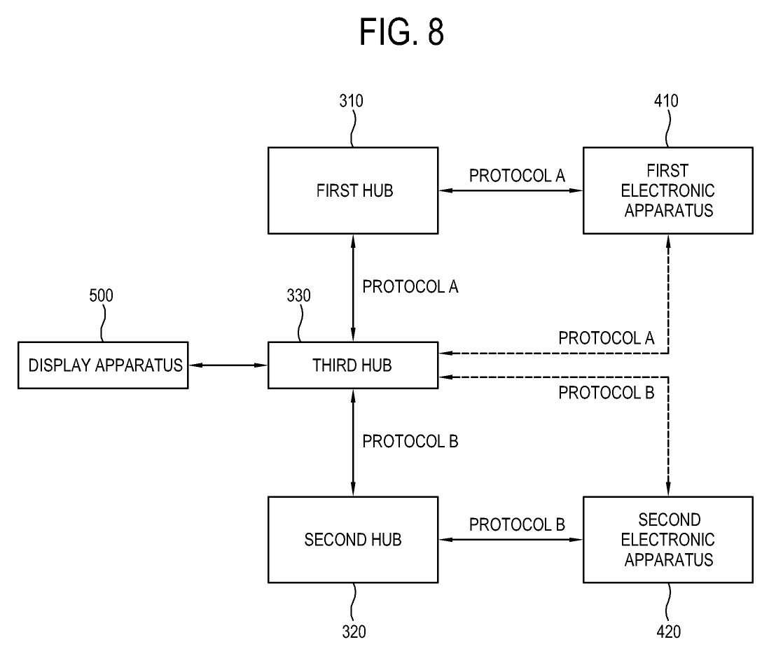

FIG. 8 is a block diagram of communication protocols between apparatuses in a system according to the third exemplary embodiment.

As shown in FIG. 8, the communication between the first hub 310 and the first electronic apparatus 410 is based on the protocol A, and the communication between the second hub 320 and the second electronic apparatus 420 is based on the protocol B. If the first hub 310 supports the protocol A and the second hub 320 supports the protocol B, the third hub 330 is needed for connection between the two unit networks since the first hub 310 and the second hub 320 are different in communication protocol.

For example, if the third hub 330 supports both the protocol A and the protocol B, the third hub 330 communicates with the first hub 310 based on the protocol A and communicates with the second hub 320 based on the protocol B, thereby connecting the first hub 310 and the second hub 320.

In this exemplary embodiment, the third hub 330 may access the first electronic apparatus 410 via the first hub 310. However, the third hub 330 may directly access the first electronic apparatus 410 without the first hub 310 if the communication between the third hub 330 and the first electronic apparatus 410 is allowed within the communication network. Likewise, the third hub 330 may access the second electronic apparatus 420 via the second hub 320, or may directly access the second electronic apparatus 420 without the second hub 320.

If many electronic apparatuses are connected to the first hub 310 or the second hub 320, such diversification of the communication channels improves communication traffic in the system.

The methods according to the foregoing exemplary embodiments may be achieved in the form of a program command that can be implemented in various computers, and recorded in a computer readable medium. Such a computer readable medium may include a program command, a data file, a data structure or the like, or combination thereof. For example, the computer readable medium may be stored in a volatile or nonvolatile storage such as a read only memory (ROM) or the like, regardless of whether it is deletable or rewritable, for example, a RAM, a memory chip, a device or integrated circuit (IC) like memory, or an optically or magnetically recordable or machine (e.g., a computer)-readable storage medium, for example, a compact disk (CD), a digital versatile disk (DVD), a magnetic disk, a magnetic tape or the like. It will be appreciated that a memory, which can be included in a mobile terminal, is an example of the machine-readable storage medium suitable for storing a program having instructions for realizing the exemplary embodiments. The program command recorded in this storage medium may be specially designed and configured according to the exemplary embodiments, or may be publicly known and available to those skilled in the art of computer software.

Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display;
a communicator configured to communicate with a third hub;
a user input configured to receive a user's input; and
a processor configured:
to receive information about a list of apparatuses, which are connected to a first hub and a second hub using a different protocol from the first hub, through the third hub,
to control the display to display a list of first electronic apparatuses connected to the first hub and second electronic apparatuses connected to the second hub based on the received information about the list of apparatuses, and
to control an operation of an electronic apparatus selected by a user's input to the user input among the first electronic apparatuses and the second electronic apparatuses.

2. The display apparatus according to claim 1, wherein the processor controls the display to display a user interface (UI) for changing a setting value of a current environmental setting state of the electronic apparatus selected in the list, and transmits information about the setting value changed through the UI to the electronic apparatus selected in the list.

3. The display apparatus according to claim 2, wherein the processor acquires setting information about the first electronic apparatuses and the second electronic apparatuses from the first hub and the second hub, stores the acquired setting information in the third hub, and determines a current environmental setting state of the electronic apparatus selected in the list based on the stored setting information.

4. The display apparatus according to claim 1, wherein the user input is configured to receive a user's input from a remote controller.

5. The display apparatus according to claim 1, wherein the display apparatus comprises the third hub.

6. A method of controlling a display apparatus, the method comprising:
communicating with a third hub;
receiving information about a list of apparatuses, which are connected to a first hub and a second hub using a different protocol from the first hub, through the third hub;
displaying a list of first electronic apparatuses connected to the first hub and second electronic apparatuses connected to the second hub based on the received information about the list of apparatuses; and
controlling an operation of an electronic apparatus selected by a user's input among the first electronic apparatuses and the second electronic apparatuses.

7. The method according to claim 6, wherein the controlling an operation of an electronic apparatus selected by a user's input comprises:
displaying a user interface (UI) for changing a setting value of a current environmental setting state of the electronic apparatus selected in the list; and
transmitting information about the setting value changed through the UI to the electronic apparatus selected in the list.

8. The method according to claim 7, further comprising:
acquiring setting information about the first electronic apparatuses and the second electronic apparatuses from the first hub and the second hub, and storing the acquired setting information in the third hub; and
determining a current environmental setting state of the electronic apparatus selected in the list based on the stored setting information.

9. The method according to claim 6, wherein the user input is configured to receive a user's input from a remote controller.

10. The method according to claim 6, wherein the display apparatus comprises the third hub.

11. A system comprising:
a first hub;
a second hub using a different protocol from the first hub;
a third hub connected to each of the first hub and the second hub,
the third hub comprising:
a communicator configured to communicate with each of the first hub and the second hub;
a user input configured to receive a user's input; and
a processor configured to receive information about a list of apparatuses connected to the first hub, control a display to display a list of first electronic apparatuses connected to the first hub and second electronic apparatuses connected to the second hub based on the received information about the list of apparatuses, and control an operation of an electronic apparatus selected by a user's input to the user input among the first electronic apparatuses and the second electronic apparatuses.

12. The system according to claim 11, wherein the first hub is configured to use a first protocol and the second hub is configured to use the second protocol, and
the third hub is configured to convert a command based on one of the first protocol and the second protocol, received from the first electronic apparatus or the second electronic apparatus, into a command based on the other one of the first protocol and the second protocol.

13. The system according to claim 11, wherein the third hub comprises the display.

14. The system according to claim 13, wherein
the processor controls the display to display a user interface (UI) for changing a setting value of a current environmental setting state of the electronic apparatus selected in the list, and transmits information about the setting value changed through the UI to the electronic apparatus selected in the list.

15. The system according to claim 14, wherein the processor acquires setting information about the first electronic apparatuses and the second electronic apparatuses from the first hub and the second hub, stores the acquired setting information in the third hub, and determines a current environmental setting state of the electronic apparatus selected in the list based on the stored setting information.

16. The system according to claim 11, wherein the communicator communicates with an external apparatus comprising the display.

17. The system according to claim 11, wherein the user input receives a user's input from the remote controller.
